(19) United States
(12) Patent Application Publication
(10) Pub. No.: US 2021/0243583 A1
(43) Pub. Date: Aug. 5, 2021

(54) LOCATION BASED EMERGENCY ALERT

(71) Applicant: Microsoft Technology Licensing, LLC, Redmond, WA (US)

(72) Inventor: Amer Aref Hassan, Kirkland, WA (US)

(21) Appl. No.: 16/780,545

(22) Filed: Feb. 3, 2020

(51) Int. Cl. H04W 4/90; H04W 4/02; H04W 4/12; H04W 68/00

(52) U.S. Cl. CPC H04W 4/90; H04W 68/005; H04W 4/12; H04W 4/023

(57) ABSTRACT

Systems and methods may be used for alerting a device with information related to a nearby emergency. These systems and methods may include receiving a plurality of emergency communications from a corresponding plurality of user devices, determining an emergency location based on locations of the plurality of user devices based on the plurality of emergency communications, and determining whether the plurality of emergency communications at the emergency location exceed a threshold number of emergency communications. Proximate user devices may be identified, and an alert may be sent to at least one of the proximate user devices.

### BACKGROUND

In traditional 911 or other emergency service calls, for example in the United States, a landline's location is automatically sent to a dispatcher receiving the call. In addition to landline emergency services, enhanced 911 (e.g., e911 or E112 in Europe) is available for aiding in location determination for an emergency call from a mobile device (e.g., a cell phone). Some jurisdictions now provide emergency service contacts via text message on a mobile device, often referred to as text-to-911. However, response times for emergency communications may still be delayed, despite these new techniques.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example schematic diagram showing an overview of an emergency service system according to some examples of the present disclosure.

FIG. 2 illustrates an example schematic diagram showing devices for providing an emergency service according to some examples of the present disclosure.

FIG. 3 illustrates an example mobile device for displaying an alert according to some examples of the present disclosure.

FIG. 4 illustrates a diagram of a map illustrating location information according to some examples of the present disclosure.

FIGS. 5-6 illustrate flowcharts of techniques for providing an emergency service at a mobile device according to some examples of the present disclosure.

FIG. 7 illustrates a block diagram of an example machine which may implement one or more of the techniques discussed herein according to some examples of the present disclosure.

### DETAILED DESCRIPTION

Systems and methods for alerting devices in an area about an emergency situation are described herein. The systems and methods may be used to provide devices in the area directions to avoid or to assist with the emergency situation. An emergency situation may be detected, for example, based on a large number of emergency communications (e.g., calls, texts, etc.) initiated from a location. An emergency service system (e.g., a call center, a server, an emergency response device, or the like) may determine that an area is subject to an emergency, select an alert, and send the alert. Alerts may vary according to recipient, location, emergency type, number of devices, response time or availability of emergency responders, or the like.

These systems and methods may be used to receive a plurality of emergency communications from a corresponding plurality of user devices. When a number of received emergency communications exceeds a threshold number of emergency communications, an emergency location may be determined. Devices that are proximate to the emergency location (e.g., within a predetermined proximity) may be sent an alert. The predetermined proximity may include a physical distance from an address or location (e.g., a radius around the address or location, a number of blocks away, etc.) or a communication distance (e.g., within range of a particular cell tower, within communication distance of an emergency beacon or device in contact with an emergency service system, or the like).

The systems and methods described herein solve the technical issues involved with communication channel congestion when a device is attempting or engaging in an emergency communication. These solutions allow for communications to occur to devices near an emergency situation to mitigate unnecessary network traffic. Unnecessary network traffic may be avoided by advising devices to avoid an emergency situation, setting up a beacon to communicate locally with devices, alerting devices before they initiate emergency communications, or the like. These solutions may improve network communications by alerting devices that are unaware of the emergency to avoid the area, preventing further potential injury, damage, or loss.

The systems and methods described herein further solve technical issues associated with logistical issues in dispatching emergency services. Emergency services may be delayed or complicated by logistical issues, such as traffic, other emergency situations, location determination, or the like. These issues may be avoided by alerting a nearby user device operated by a user with one or more emergency service skills to assist in the emergency situation, while also optionally advising devices operated by users without needed skills to avoid the emergency situation. The avoiding users may be alerted to clear away from the emergency situation before emergency services arrive, lowering traffic or congestion. The assisting users may provide emergency services quicker than official dispatched emergency service providers, which may prevent an emergency situation from escalating.

The systems and methods described herein include location-based aspects, such as including identifying devices near an emergency situation. The location of the emergency situation may include an address or other location information, such as an intersection, a landmark, coordinates, or the like. An address may be generated from previously user entered addresses (e.g., of a device initiating an emergency service), from automatic location data of the mobile device (e.g., GPS, an address of a device connected to the mobile device including an access point (AP) or an Evolved Terrestrial Radio Access Network (E-UTRAN) node B (eNodeB), RFID, other mobile devices nearby, geofencing information, NFC, or the like), or from a combination (e.g., using location information from two or more devices). An address generated from a combination of automatic and user entered addresses may include a partially entered address by a user that is completed using location data (e.g., from a map database or app). For example, if the user has entered 101 First Ave, a compass direction, a city, a state, or a zip code may be added based on location data.

In another example, the address may be generated from location data received at a mobile device (e.g., a mobile device that initiated an emergency communication or an eavesdropping mobile device). The location data may be generated from communication with a device having a known location (e.g., a static device) or a device having a likely address (e.g., another mobile device, which may be used to compare to the mobile device's own location data, for example from GPS, to verify, for example when both mobile devices have matching addresses, the likelihood of that probable location increases). Example devices the mobile device may communicate with include an access point (e.g., a WiFi access point), an eNodeB or other base station for communicating over a wireless network, a GPS satellite, a geofence, an RFID or NFC device, a Bluetooth device, a desktop computer, a smart device (e.g., a thermostat, refrigerator, home security system, etc.), a printer, or the like.

In yet another example, an address may be derived from a saved place or an often-frequented place, such as based on data from a map app or location services of the mobile device. For example, a user may keep a home or work address in a map app. In an example, the address of a mobile device may be inferred from map app data. For example, when the mobile device has two or more probable locations, one may be selected based on user data, such as a to-be-visited or starred address on a map app, a home or work address, an address stored in a contact list, an address associated with a calendar appointment for a current time, or the like.

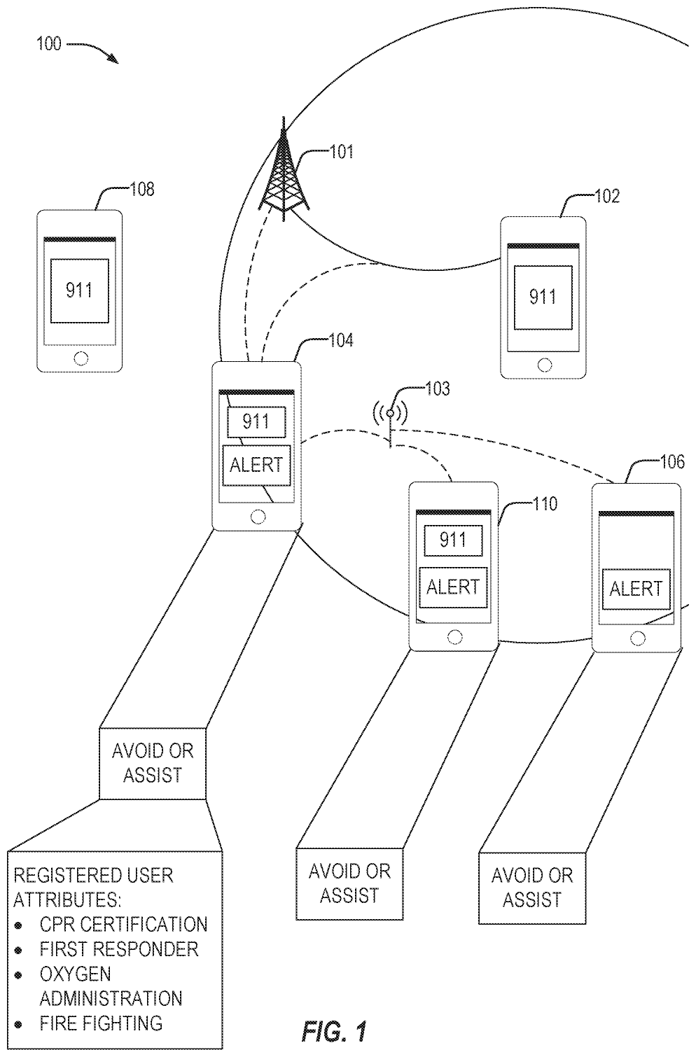

FIG. 1 illustrates an example schematic diagram 100 showing an overview of an emergency service system according to some examples of the present disclosure. The schematic diagram 100 includes a communications tower 101 (e.g., a cell tower) that is in communication with a device 102 that initiates or is engaged in an emergency communication. The device 102 may call, text, or otherwise (e.g., via an app) communicate or attempt to communicate that an emergency has occurred or is occurring. In an example, the device 102 may connect or may not connect with an emergency service system, but the device 102 may be located at an emergency location. In another example, the emergency location may not be associated with a particular device, but instead be located proximate two or more devices (e.g., a fire at a building).

The emergency situation may be reported via an emergency communication from a plurality of devices, for example devices 102, 104, 108, or 110. These example devices may be mobile devices (e.g., cell phones) or other devices having communication capabilities (e.g., a computer). These devices may communicate with an emergency service system to provide location information about an emergency situation at an emergency location. The emergency location may be determined from one or more of the locations of these devices (e.g., provided by a user or automatically obtained at a respective device).

After the emergency situation is identified at an emergency service system, the system may determine appropriate alerts to provide to various devices. For example, the system may determine a type of emergency, a location of the emergency, skills or assistance needed for the emergency or type of emergency, available resources, logistics information (e.g., time of arrival of a particular resource), traffic, weather, etc. for use in evaluating information to provide to devices proximate the emergency location. In an example, the alerts may be determined by a trained person of the emergency service system. In another example, the alerts may be determined automatically based on machine learning (e.g., using past training or testing data) or based on predetermined relationships among the input variables and available alerts.

The emergency service system may determine or receive an emergency location. Based on the emergency location, proximate devices may be identified. Proximate devices may include those within a particular physical distance or communication range of the emergency location, or may be based on predicted or identified time to respond to the alert for a particular device. For example, proximate devices may include all devices within a mile, a few blocks, communication range of the communications tower 101 or a beacon 103, communication range of an originating device 102, time to arrive at the emergency location (e.g., based on identified method of transport, for example if device 104 is currently connected to a vehicle, it may be able to arrive at the emergency location quicker than device 110 when that device is identified to be held by a walking user or has a more congested route (e.g., traffic), identified for example from map data, even if device 110 is physically closer to the emergency location), or the like. In another example, the proximate devices may be assumed to include any devices within a communication range of the tower 101, the beacon 103, or the originating device 102, any or all of which may broadcast or communicate with proximate devices within the communication range. For example any device that receives an alert from the beacon 103 may be considered proximate to the beacon 103. In yet another example, the beacon 103 may be virtual, with communications conducted by, for example, the tower 101 with devices that are within a proximity of the virtual beacon 103 (e.g., within a specified distance).

An alert need not be sent to all proximate devices or all devices that provide an emergency communication to the emergency service system. For example, while device 108 may have provided an emergency communication, it may not be proximate the emergency location (or may be moving away from the emergency location) and may not need an alert. On the other hand, device 106 may not have provided an emergency communication, but may be proximate or heading toward the emergency location, and may be alerted.

The alerts provided to proximate devices may be general (e.g., provided to all proximate devices) or specific (e.g., individualized to a particular device or set of devices). A default alert may be used. For example, a default alert may include instructions to avoid an emergency location (e.g., avoid 101 First Ave). Further details may be provided if asked for at a particular device, such as driving directions away from the emergency location. The default alert may be sent to all but a selected set of devices. The selected set of devices may be those that the emergency service system has previously identified as potentially useful to assisting in the emergency. The prior identification may be based on emergency type, location, proximity, time, or the like, and thus not specific to the particular device. The prior information may be based on specific information corresponding to a particular device (e.g., device 104 may be owned or operated by a user with emergency service skills).

An alert may indicate that the user of a receiving device should avoid the emergency location or assist in the emergency situation. For devices receiving the avoid indication, general information may be provided (e.g., avoid downtown), and specific information may be avoided (e.g., reasons why). For devices receiving the assist indication, more specific information than the avoid indication may be provided. For example, an exact location, skills needed, tools needed, or the like may be provided to an assist indicated device.

An alert indicating that a device should assist in the emergency situation may include an option to accept the request for assistance or an option to deny (e.g., an alert may include an opt-in or may include an opt-out, or may require a response opting in or opting out). Opting in may be used in examples where a person is off-duty, a civilian, or the like. Opting out may be used in examples with an active emergency service provider. When a user opts out, another device may be sent the alert. A response indicating that the user of an assisting indicated device intends to assist in the emergency situation may be received by an emergency service system, which may then provide further details about the emergency, such as vital signs of a victim, description of circumstances of the emergency situation, or the like.

An alert indicating assistance requested or required may be based on emergency type, a location of the emergency, skills or assistance needed for the emergency or type of emergency, available resources, logistics information (e.g., time of arrival of a particular resource), traffic, weather, or the like. For example, when the emergency situation is a fire, those with advanced certification or experience in fire rescue, firefighting, etc., may be asked to assist, while those with only CPR or first aid experience may be instructed to avoid the fire. When the emergency situation is an unconscious individual, for example, anyone (or the most proximate one or few devices) may be asked to assist who has CPR training or experience. In other emergencies, proximity may be the sole determinant, such as when an emergency levee is needed and people are needed to place sandbags.

An alert indicating assistance requested or required may be based on availability of emergency services. For example, when emergency services are only a minute or a few minutes away, all devices may be told to avoid the emergency location. However, when emergency services are further away, such as 15 or more minutes away, a proximate device may be alerted to assist, even if the user of the proximate device does not have any or all potentially needed skills. A combination approach may be used in other examples, such as only requesting assistance of devices registered to have a particular skill when emergency services are a particular number of minutes away (e.g., 10), and otherwise alerting devices to avoid the emergency location, even if that means no devices assist (e.g., in emergency situations where only skilled individuals are likely to help).

The alert may indicate that a user of a device should assist when skills or experience of the user match skills or experience needed at the emergency. The assist alert may be sent to a device, such as device 104 in response to a determination that a user of the device 104 has skills or experience needed at the emergency. The determination may be made by the device 104, for example based on user-identified need (e.g., as communicated in an emergency communication from the device 104 to an emergency service system) or based on information received from an emergency service system (e.g., in a follow up communication to the device 104 or during an emergency communication involving the device 104). In another example, the determination may be made by the emergency service system. In this example, the emergency service system may identify emergency services needed for the emergency, for example based on emergency communications received from one or more devices, user-submitted information, automatic device information (e.g., temperature, local weather, crash data such as from accelerometer data, or the like).

Once the needed emergency services are identified, proximate devices to the emergency, devices on a trajectory to the emergency, or devices within a particular range of the emergency may be identified. Of the identified devices, skills or experience of users of the identified devices may be determined. Determining the skills or experience of users of identified devices may include receiving information from one or more of the identified directly (e.g., during an emergency communication), or pulling the information from a database. For example, a user may register specific skills or experience, and the registration may be stored at the user's device or in a database. In an example, the skills or experience may include a certification, for example from a certifying organization (e.g., Red Cross for CPR or oxygen administration, state or local government for first responder, etc.). In another example, a user may register a skill or experience with a cellular carrier, which may verify the skill or experience (e.g., with the Red Cross). The cellular carrier may maintain a database that may be accessible to an emergency service system or the cellular carrier may send a token to the registered device, which may be sent to the emergency service system during an emergency communication or in response to an alert.

Based on the attributes determined to be needed for responding to the emergency, selections may be made using the set of attributes corresponding to users of devices available to assist. For example, all devices within a proximity that have a skill matching a needed skill may be sent an alert requesting assistance. In some examples, a subset of all devices may be sent an alert requesting assistance, such as one device (e.g., serially requesting assistance from devices until a user accepts), or a plurality of devices (e.g., fewer than all devices when many devices are available). A device may be selected for an assistance alert based on skill level (e.g., some experience, certified, number of years of experience, etc.), proximity (e.g., time or distance to the emergency), or based on time of response (e.g., first user to respond will be selected, others will have their assist alert changed to avoid or canceled). After a device is selected to receive an alert requesting assistance, the alert may be sent to the selected device.

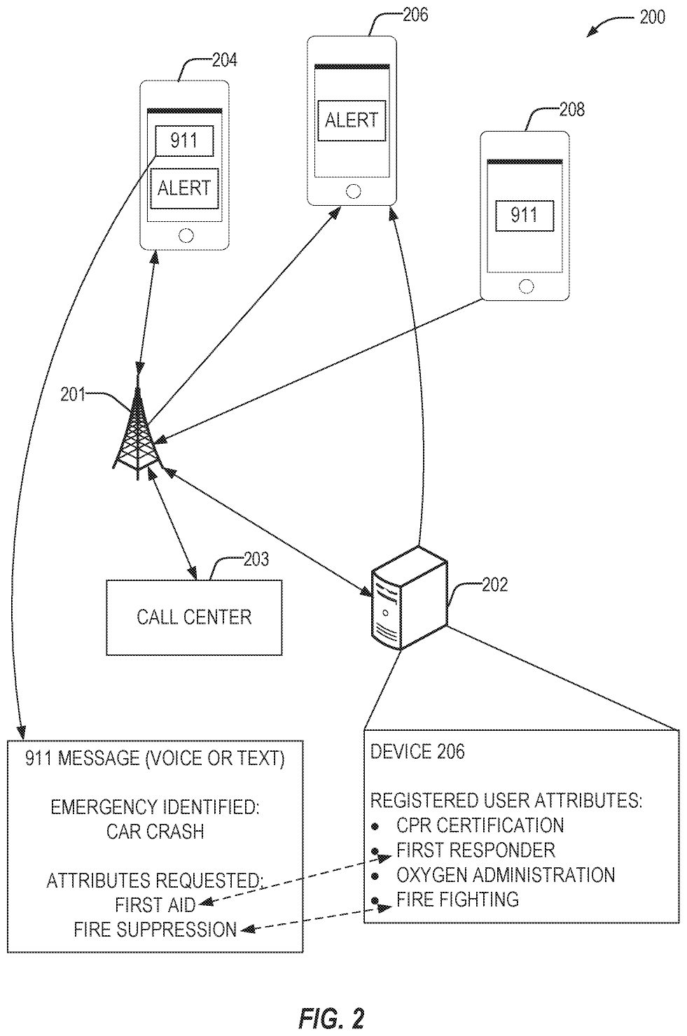

FIG. 2 illustrates an example schematic diagram 200 showing devices for providing an emergency service according to some examples of the present disclosure. The diagram 200 includes a communications tower 201, which may communicate with one or more devices (e.g., a mobile device), such as devices 204, 206, or 208. The communications tower 201 may forward communications to a server 202 or a call center 203. The server 202 may include a plurality of servers, a database, etc. The call center 203 or the server 202 may be a component of an emergency service system. For example, the server 202 may communicate with devices 204, 206, or 208 to receive an emergency communication or provide an alert. The call center 203 may receive a call or text from one of devices 204, 206, or 208, and may respond (e.g., with a human operator or with a digital assistant).

In an example, devices 204 and 208 initiate an emergency communication via the communications tower 201 (e.g., with an emergency service system, such as with server 202 or call center 203). In response to detecting the two devices, the emergency service system (e.g., the server 202 or the call center 203) may determine that a minimum threshold number of devices have initiated an emergency communication (e.g., in this example, the threshold is 2 or more, but may be higher in other examples). In response to determining that the minimum threshold is met or exceeded, the emergency service system may send an alert to devices proximate to the emergency. In the example of FIG. 2, devices 204 and 206 are proximate (while device 208 is not or is no longer proximate), and thus devices 204 and 206 may receive an alert (e.g., from server 202 or call center 203). An alert to one of devices 204 or 206 may include an indication to avoid the emergency or to assist or ask for assistance in the emergency.

A particular device may be registered with skills of a user. For example, a user may register a mobile device with the user's CPR certification. In another example, a device may belong to an emergency service provider or an employee or volunteer of an emergency service provider, and may be registered to include skills of the employee or volunteer (e.g., firefighting, CPR, emergency medical services, scuba, etc.). The registration information may be sent when an emergency communication is sent to an emergency service system or may be stored by the emergency service system (e.g., in a registry or database, for example at server 202) and retrieved based on a device ID. In an example where registration information is sent with an emergency communication, devices such as device 206 may be alerted to avoid based on unknown skills or device type, while device 204 may be asked to assist (e.g., since device 204 has an active or previously initiated emergency communication with the emergency service system). In another example where registration information is sent with the emergency communication, devices such as device 206 may be queried for their registration information before the alert is sent. The alert may request assistance from a device based on a number of devices available to assist (e.g., based on stored skills at the server 202 for proximate devices). For example, fewer than all devices available with matching skills that are needed at an emergency may be requested to assist.

Stored skills may be matched to needed skills using natural language processing, a supervised technique, or based on categories. Natural language processing may be used to identify an emergency type (e.g., when an emergency communication mentions a car crash, the word “crash” or “injury” may be identified). Skills needed for the emergency type may be predetermined, for example “crash” or “injury” may correspond to a category of emergency type that needs first aid skills. The emergency type or attributes requested may be parsed from the emergency communication or selected by a user of an emergency service system. After the needed attributes are identified, available devices (e.g., proximate as described above) may be queried or searched (e.g., using a device ID, a database such as at server 202 may be searched) to identify registered user attributes.

In the example shown in FIG. 2, an emergency communication from device 204 identifies a car crash, which may correspond to an emergency type requiring first aid, and optionally fire suppression experience (e.g., when a fire is identified from the emergency communication, via natural language processing or from a user of an emergency service system). The emergency service system may query or search device 206, after identifying device 206 as proximate or available to assist the emergency, for registered user attributes. In this example, the registered user attributes of device 206 include CPR certification, first responder, oxygen administration, and firefighting. Device 206 may be sent an alert to assist in the emergency based on matching the first responder skill of the registered user to the first aid skill needed, and optionally the firefighting skill of the registered user to the fire suppression skill needed. In an example, when multiple skills are needed, devices that have matches to two or more needed skills may be prioritized over devices with one (or fewer than the two or more matches) skills matching.

In an example, the device 204 is operated by a user that is stressed and contacting emergency services, and the device 206 hears the radio signal and determines that the communication is an emergency call. Information may be communicated by the device 206 (e.g., location of the first device 204, a time stamp, etc.), which the device 208 overhears. For example, in this example, the device 208 does not overhear or detect the initial emergency communication from the device 204, but instead overhears or detects (e.g., from a direct communication with the device 206) the information communicated by the device 206 (e.g., to the antenna 208). The device 208 may forward the overheard information, including optionally adding additional information, such as an approximate location of the device 208, an estimated distance from the device 208 to the device 206 or the device 204 (or the emergency), a time stamp, registered user attributes or the like.

The device 208 acts within a network that relays or meshes information with constraints (in an example, the information includes dialing a telephone number and the constraint includes a need for emergency services). A device may make a determinization or perform an action that is a function of the constraint (in the example, the device 206 makes a decision to respond to the emergency with available user attributes or identification of availability to assist, while optionally passing location information to a network, while the device 208 may make a determination to forward the information from the device 206 to a broader network, e.g., via the communications tower 201), or send availability to assist or available user attributes of the device 208.

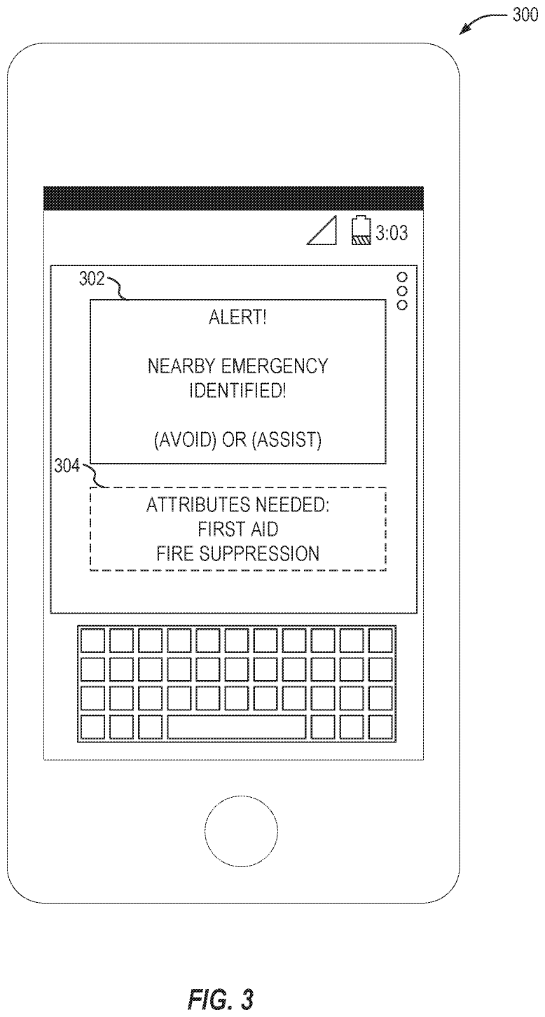

FIG. 3 illustrates an example mobile device 300 for displaying an alert 302 according to some examples of the present disclosure. The alert 302 may indicate that a user of the mobile device 300 should avoid an emergency or assist in the emergency. The alert 302 may include information about a nearby emergency, such as a location (general, such as downtown, a city, an interstate highway, a neighborhood, etc., or specific, such as an intersection, an address, a building, etc.), type of assistance needed (when the alert 302 is asking for assistance), details on how to assist or avoid the emergency (e.g., directions to or away from the emergency), or the like.

The alert 302 may include an initial request for assistance that may be accepted or declined. The mobile device 300 may, in response to sending acceptance of the assistance request, receive additional details about the emergency. Further details may be provided to the mobile device 300 when the alert 302 is requesting assistance (whether the request is accepted or not), for example an escalating request for assistance (e.g., when the need for help at the emergency increases or no other assistance is available or inadequate assistance is forthcoming, etc.), a change from a request to avoid to a request to assist or a change from a request to assist to a request to avoid (e.g., based on other assistance available or identified by an emergency service system), or the like. For example, an initial alert to avoid may change to a request for assistance if other devices that were previously requested to assist are unavailable.

The mobile device 300 may display an indication 304 including attributes needed (e.g., skills or experience) for assisting in an emergency. The indication 304 may be sent in response to a user of the mobile device 300 accepting or requesting additional information for the assistance request in the alert 302 or may be sent along with the alert 302 (e.g., in a single message). The indication 304 may include location information, additional emergency information (e.g., for first aid, the additional information may include patient information or for fire suppression, the additional information may include type of fire), directions to the emergency, or the like.

In an example, emergency types may include situational occurrences (e.g., an accident) or results (e.g., an injury). An emergency type may include an accident (e.g., car crash, slip and fall, etc.), an injury (e.g., broken bone, blood loss, concussion, etc.), building/vehicle fire, natural disaster (e.g., flood, earthquake, wildfire, lightning, snow storm, freezing or hot temperatures which may lead to frostbite or heatstroke, landslide, hurricane, tornado, tsunami, volcano, etc.), chemical spill, radiation exposure, disease outbreak, poison, terrorism, crowd control issue or rioting, or the like.

In an example, attributes of a user may include skills (e.g., certified or uncertified) or experience (e.g., number of years performing a job, number of times performing an action, or more generally experience in a certain field or area). Skills or experience may be specific (e.g., forest firefighting) or general (e.g., firefighting). The attributes may include first responder experience, CPR, oxygen administration, first aid experience (e.g., wound care, bone setting, blood loss care, hypothermia care, heatstroke or sunstroke care, etc.), accident assessment or management (e.g., use of jaws of life, victim extraction from car crash, structural engineering for building accidents or collapses, etc.), natural disaster response skills or experience (e.g., skills or experience with levee building, dam structures, tornado or hurricane cleanup, firefighting, etc.), chemical spill or injury treatment, radiation expertise, disease prevention or vector management, poison or venom treatment, antiterrorism, crowd control, policing, or the like.

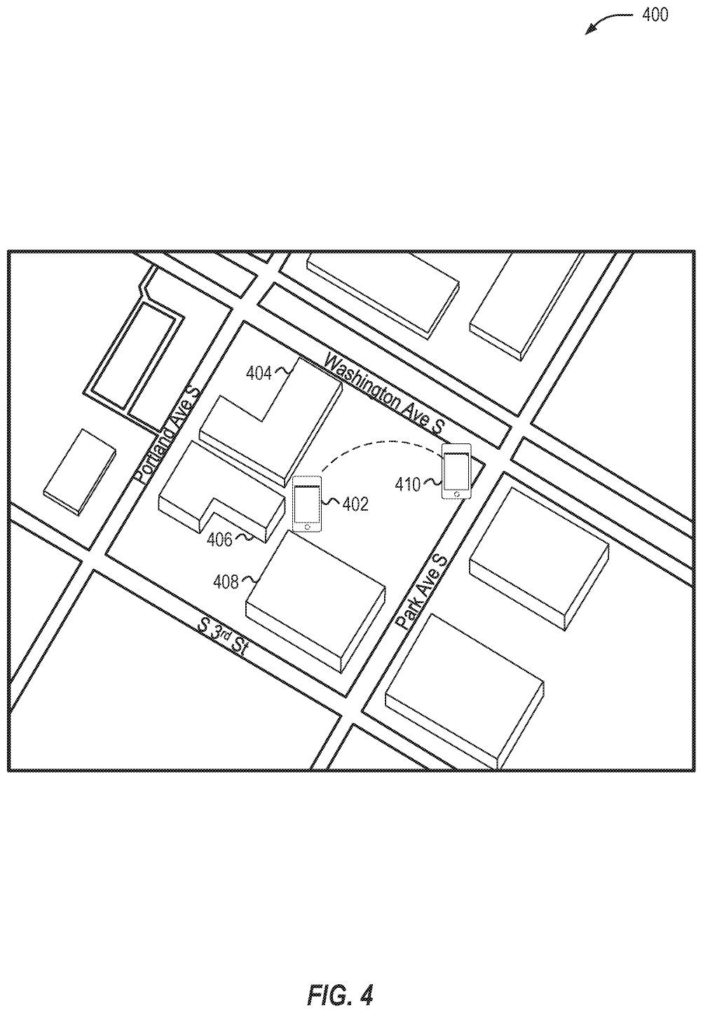

FIG. 4 illustrates a diagram of a map 400 illustrating location information according to some examples of the present disclosure. The map 400 shows a first mobile device 402, along with a one or more likely locations (e.g., addresses) for example locations 404, 406, or 408. The map 400 is representative of various locations to show proximity and the potential for difficulty in determining an accurate address of the first mobile device 402.

The location within the map 400 of the first mobile device 402 may be determined using any of the techniques described herein (e.g., from an eNodeB, an access point, another device with a known location, a user entered address, GPS, etc.). The locations 404, 406, and 408 may, in an example, be determined as potential locations of the first mobile device 402. One of the locations 404, 406, and 408 may be selected as a probable location of the first mobile device 402 based on location data (e.g., a closest of the potential locations).

A second mobile device 410 is shown on the map 400. The second mobile device 410 may generate or receive the location information for the first mobile device 402, for example from GPS coordinates of the second mobile device 410, from direct communications between the two mobile devices, from network traffic sent by the first mobile device 402 (e.g., in clear text, as intercepted by the second mobile device 410), from an antenna (e.g., an eNodeB, a Wi-Fi access point, etc.), from a beacon (e.g., placed by another mobile device), or the like.

An emergency service system may use location information from the first mobile device 402 or the second mobile device 410 or both to determine an emergency location. The emergency service system may determine whether a threshold number of devices have indicated an emergency exists before sending out an alert to one or more devices proximate to the emergency location (once determined). In an example, the threshold may be two devices, and thus the example shown in FIG. 4 may be sufficient to trigger alerts sent to the first mobile device 402 or the second mobile device 410 (or other devices) based on whether the first or second mobile devices 402 or 410 are proximate the emergency location (e.g., one or both devices may have moved after identifying the emergency, and thus are no longer near the emergency location). In another example, the threshold may be higher than two, and no alerts may be sent to the first or second mobile devices 402 or 410 or any other devices proximate the emergency location. Alerts sent to the first or second mobile devices 402 or 410 or any other devices proximate the emergency location may include instructions to avoid or assist with the emergency.

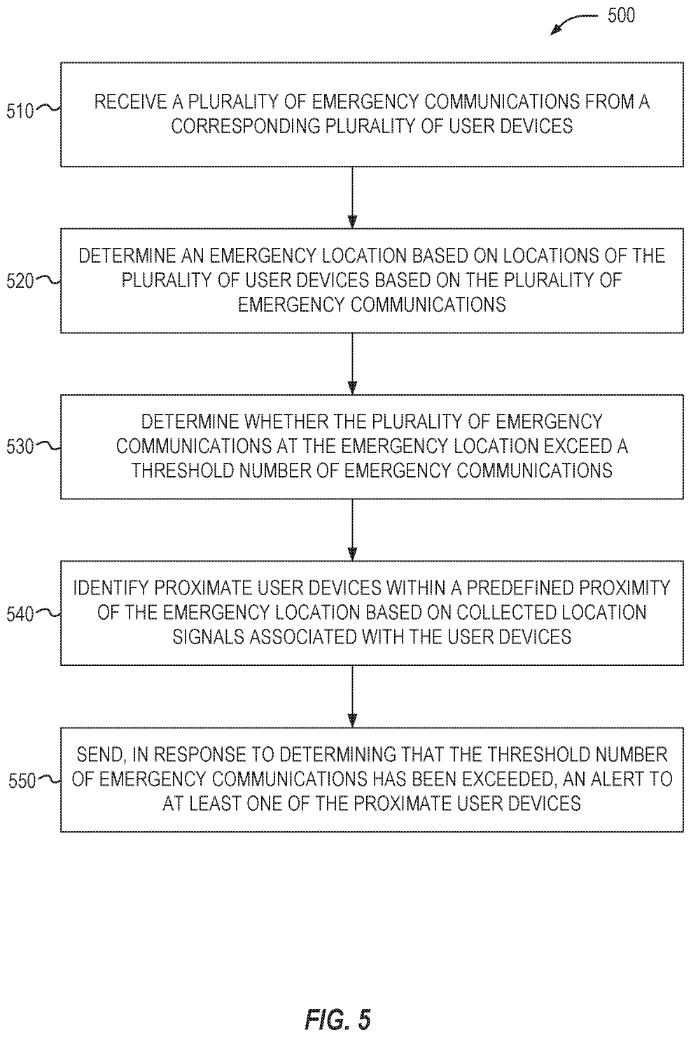

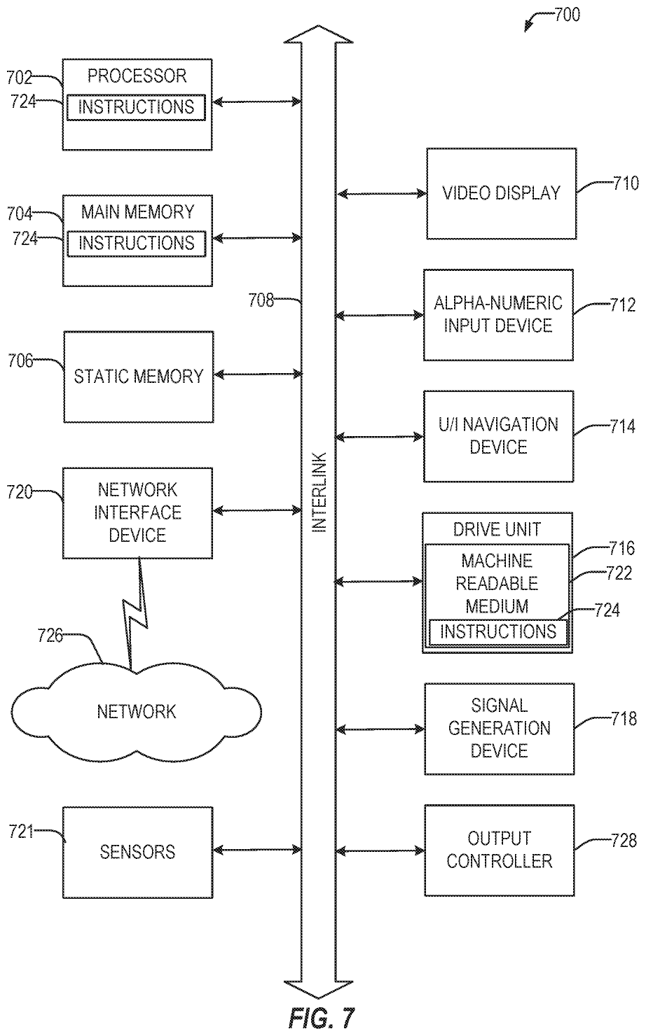

FIG. 5 illustrates a flowchart of a technique 500 for providing an emergency service at a mobile device according to some examples of the present disclosure. The technique 500 may be performed using a processor or processors of the mobile device (e.g., as discussed in further detail below with respect to FIG. 7).

The technique 500 includes an operation 510 to receive a plurality of emergency communications from a corresponding plurality of user devices. In an example, the plurality of emergency communications include at least one text message or at least one phone call. The technique 500 includes an operation 520 to determine an emergency location based on locations of the plurality of user devices based on the plurality of emergency communications. The technique 500 includes an operation 530 to determine whether the plurality of emergency communications at the emergency location exceed a threshold number of emergency communications.

The technique 500 includes an operation 540 to identify proximate user devices within a predefined proximity of the emergency location based on collected location signals associated with the user devices. In an example, the proximate user devices may be identified directly from the proximate user devices themselves or through a server based on respective IP addresses of the proximate user devices.

The technique 500 includes an operation 550 to send, in response to determining that the threshold number of emergency communications has been exceeded, an alert to at least one of the proximate user devices. Operation 550 may include sending the alert to at least one device not among the plurality of user devices, such as based on a location of the at least one device corresponding to the emergency location. Operation 550 may include refraining from sending the alert to at least one other user device of the plurality of user devices, for example based on the at least one other user device not being in or near the emergency location. In an example, sending the alert includes sending the alert to all of the plurality of user devices, or all of the plurality of user devices that remain proximate to the to the emergency location. In another example, sending the alert includes sending the alert to all of the proximate user devices. The technique 500 may include determining a type of alert based on the plurality of emergency communications, the alert having the type.

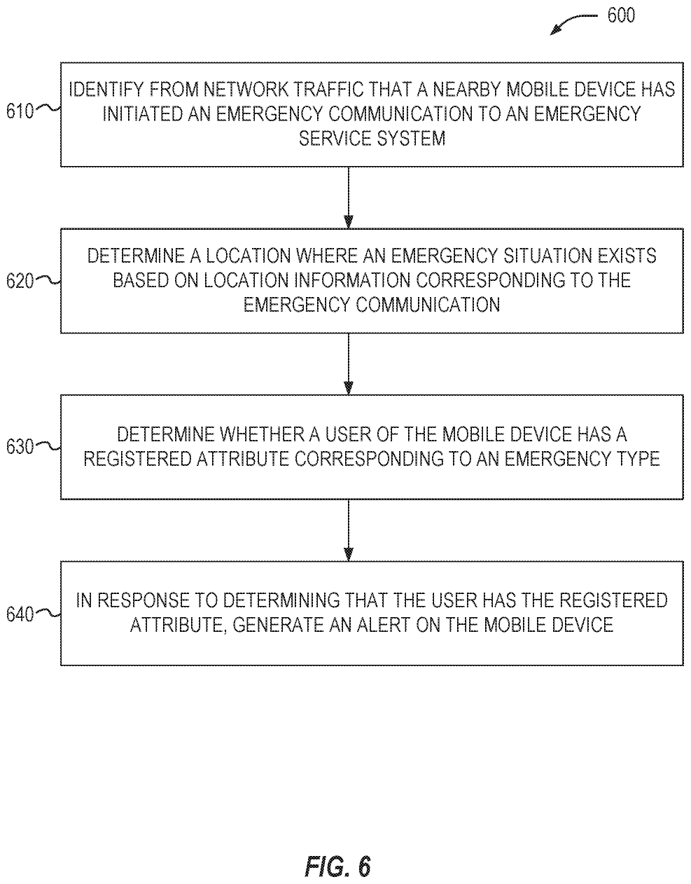

FIG. 6 illustrates a flowchart of a technique 600 for providing an emergency service at a mobile device according to some examples of the present disclosure. The technique 600 may be performed using a processor or processors of the mobile device (e.g., as discussed in further detail below with respect to FIG. 7). In an example, the technique 600 may be performed as a background process, for example in a manner opaque to a user of the mobile device, such as until an alert is provided or some other user interaction is indicated or needed.

The technique 600 includes an operation 610 to identify from network traffic that a nearby mobile device has initiated an emergency communication to an emergency service system. Operation 610 may include determining that the emergency communication has been initiated based on wireless signals received by the mobile device. The nearby mobile device may be within (or determined to be within) a communication range of the mobile device. The emergency communication may be identifiable via the network traffic (e.g., based on clear signals sent by the nearby mobile device or the emergency service system, for example based on eavesdropping by the mobile device). Operation 610 may include detecting a beacon activated by the nearby mobile device or another device (e.g., on behalf of the nearby mobile device).

The technique 600 includes an operation 620 to determine a location where an emergency situation exists based on location information corresponding to the emergency communication. The location may be determined based on a location of the nearby mobile device, based on a location of the mobile device, or based on one or more locations of other devices (e.g., in a communications chain or a mesh network). For example, a location may be estimated for the emergency based on a signal strength of the emergency communication received and a location range of the mobile device. In another example, other nearby mobile devices may be communicated with to obtain their locations and distances to the nearby mobile device and combine the data to triangulate the position of the nearby mobile device. In yet another example, an emergency service system may be sent a message from the mobile device, the message indicating that the mobile device is available to assist the emergency. The nearby mobile device may issue a beacon (that the mobile device uses to identify the emergency). In still another example, an emergency service system may send a message to mobile devices proximate the nearby mobile device (such as the mobile device).

The technique 600 includes an operation 630 to determine whether a user of the mobile device has a registered attribute corresponding to an emergency type. The emergency type may be identified from keywords or metadata of the emergency communication, in an example. In another example, the emergency type may be identified from a message (e.g., a code, a plaintext message, etc.) sent to the mobile device, such as from the emergency service system, the nearby mobile device, or another device. In an example, the registered attribute may include one or more of CPR knowledge, firefighting training, medical training, crowd control training, law enforcement training, or suicide counseling and wherein the emergency type includes an injury, a fire, a medical emergency, a crowd emergency, a law enforcement emergency, or the like.

The technique 600 includes an operation 640 to generate, in response to determining that the user has the registered attribute, an alert on the mobile device. The alert may include the location or information related to the emergency situation (e.g., the type, assistance needed, skills needed, directions to the location, a communication protocol, contact information, or the like).

The technique 600 may further include notifying a set of other mobile devices at the location that the emergency situation exists. The notification may include setting a beacon (e.g., via a base station, wireless station, RFID tag, Bluetooth device, IoT or edge device, etc.) indicating that the emergency situation exists at the location. The beacon may broadcast or otherwise communicate with devices within a particular communication range of the beacon to alert other devices to the need for assistance with the emergency situation. The technique 600 may further include determining the location based on signal strength information between the nearby mobile device and one or more of a group of notified mobile devices. The technique 600 may further include automatically retrieving a tutorial or video relevant to the registered attribute. The technique 600 may further include providing instructions for managing the emergency situation to the user via a voice assistant.

FIG. 7 illustrates a block diagram of an example machine 700 which may implement one or more of the techniques (e.g., methodologies) discussed herein according to some examples of the present disclosure. In alternative embodiments, the machine 700 may operate as a standalone device or may be connected (e.g., networked) to other machines. In a networked deployment, the machine 700 may operate in the capacity of a server machine, a client machine, or both in server-client network environments. The machine 700 may be configured to perform the methods of FIG. 5 or 6. In an example, the machine 700 may act as a peer machine in peer-to-peer (P2P) (or other distributed) network environment. The machine 700 may be a user device, a remote device, a second remote device or other device which may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may be non-transitory machine readable media. In some examples, machine readable media may include machine readable media that is not a transitory propagating signal.

The instructions 724 may further be transmitted or received over a communications network 726 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

Example 1 is a method performed by an emergency service system comprising: receiving, at a processor of the emergency service system, a plurality of emergency communications from a corresponding plurality of user devices; determining an emergency location based on locations of the plurality of user devices based on the plurality of emergency communications; determining whether the plurality of emergency communications at the emergency location exceed a threshold number of emergency communications; and identifying proximate user devices within a predefined proximity of the emergency location based on collected location signals associated with the user devices; sending, in response to determining that the threshold number of emergency communications has been exceeded, an alert to at least one of the proximate user devices.

In Example 2, the subject matter of Example 1 includes, determining a type of alert based on the plurality of emergency communications, the alert having the type.

In Example 3, the subject matter of Examples 1-2 includes, wherein the plurality of emergency communications include at least one text message and at least one phone call.

In Example 4, the subject matter of Examples 1-3 includes, wherein sending the alert includes sending the alert to at least one device not among the plurality of user devices based on a location of the at least one device corresponding to the emergency location.

In Example 5, the subject matter of Examples 1-4 includes, refraining from sending the alert to at least one other user device of the plurality of user devices based on the at least one other user device not being in or near the emergency location.

In Example 6, the subject matter of Examples 1-5 includes, wherein sending the alert includes sending the alert to all of the plurality of user devices.

In Example 7, the subject matter of Examples 1-6 includes, wherein sending the alert includes sending the alert to all of the proximate user devices.

In Example 8, the subject matter of Examples 1-7 includes, wherein the proximate user devices are identified directly from the proximate user devices themselves or through a server based on respective IP addresses of the proximate user devices.

Example 9 is a device for providing emergency service-related information, the device comprising: one or more hardware processors; a memory, storing instructions, which when executed, cause the one or more hardware processors to perform operations comprising: receiving a plurality of emergency communications from a corresponding plurality of user devices; determining an emergency location based on locations of the plurality of user devices based on the plurality of emergency communications; determining whether the plurality of emergency communications at the emergency location exceed a threshold number of emergency communications; and identifying proximate user devices within a predefined proximity of the emergency location based on collected location signals associated with the user devices; sending, in response to determining that the threshold number of emergency communications has been exceeded, an alert to at least one of the proximate user devices.

In Example 10, the subject matter of Example 9 includes, wherein the one or more hardware processors are further configured to perform operations comprising determining a type of alert based on the plurality of emergency communications, the alert having the type.

In Example 11, the subject matter of Examples 9-10 includes, wherein the plurality of emergency communications include at least one text message and at least one phone call.

In Example 12, the subject matter of Examples 9-11 includes, wherein sending the alert includes sending the alert to at least one device not among the plurality of user devices based on a location of the at least one device corresponding to the emergency location.

In Example 13, the subject matter of Examples 9-12 includes, wherein the one or more hardware processors are further configured to perform operations comprising refraining from sending the alert to at least one other user device of the plurality of user devices based on the at least one other user device not being in or near the emergency location.

In Example 14, the subject matter of Examples 9-13 includes, wherein sending the alert includes sending the alert to all of the plurality of user devices.

In Example 15, the subject matter of Examples 9-14 includes, wherein sending the alert includes sending the alert to all of the proximate user devices.

In Example 16, the subject matter of Examples 9-15 includes, wherein the proximate user devices are identified directly from the proximate user devices themselves or through a server based on respective IP addresses of the proximate user devices.

Example 17 is an apparatus for providing emergency service-related information, the apparatus comprising: means for receiving a plurality of emergency communications from a corresponding plurality of user devices; means for determining an emergency location based on locations of the plurality of user devices based on the plurality of emergency communications; means for determining whether the plurality of emergency communications at the emergency location exceed a threshold number of emergency communications; and means for identifying proximate user devices within a predefined proximity of the emergency location based on collected location signals associated with the user devices; means for sending, in response to determining that the threshold number of emergency communications has been exceeded, an alert to at least one of the proximate user devices.

In Example 18, the subject matter of Example 17 includes, means for determining a type of alert based on the plurality of emergency communications, the alert having the type.

In Example 19, the subject matter of Examples 17-18 includes, wherein the plurality of emergency communications include at least one text message and at least one phone call.

In Example 20, the subject matter of Examples 17-19 includes, wherein the means for sending the alert include means for sending the alert to at least one device not among the plurality of user devices based on a location of the at least one device corresponding to the emergency location.

Example 21 is a method performed by a mobile device, the method comprising: identifying from network traffic based on wireless signals received by the mobile device, at a processor of the mobile device, that a nearby mobile device has initiated an emergency communication to an emergency service system, the nearby mobile device within a communication range of the mobile device, and the emergency communication identifiable via the network traffic; determining a location where an emergency situation exists based on location information corresponding to the emergency communication; determining whether a user of the mobile device has a registered attribute corresponding to an emergency type identified from keywords or metadata of the emergency communication; and in response to determining that the user has the registered attribute, generating an alert on the mobile device including the location and information related to the emergency situation.

In Example 22, the subject matter of Example 21 includes, wherein the location is based on a location of the nearby mobile device.

In Example 23, the subject matter of Examples 21-22 includes, wherein the registered attribute includes at least one of CPR knowledge, firefighting training, medical training, crowd control training, law enforcement training, or suicide counseling and wherein the emergency type includes an injury, a fire, a medical emergency, a crowd emergency, or a law enforcement emergency.

In Example 24, the subject matter of Examples 21-23 includes, wherein the method is performed as a background process and is opaque to the user until the alert is provided.

In Example 25, the subject matter of Examples 21-24 includes, notifying a set of other mobile devices at the location that the emergency situation exists.

In Example 26, the subject matter of Example 25 includes, wherein notifying the set of other mobile devices includes setting a beacon indicating the emergency situation exists at the location.

In Example 27, the subject matter of Examples 21-26 includes, determining the location based on signal strength information between the nearby mobile device and each of a group of notified mobile devices.

In Example 28, the subject matter of Examples 21-27 includes, wherein identifying that the nearby mobile device has initiated the emergency communication includes detecting a beacon activated by the nearby mobile device.

In Example 29, the subject matter of Examples 21-28 includes, automatically retrieving a tutorial or video relevant to the registered attribute.

In Example 30, the subject matter of Examples 21-29 includes, providing instructions for managing the emergency situation to the user via a voice assistant.

Example 31 is a mobile device for providing an emergency service, the mobile device comprising: one or more hardware processors; a memory, storing instructions, which when executed, cause the one or more hardware processors to perform operations comprising: identifying from network traffic based on wireless signals received by the mobile device, at a processor of the mobile device, that a nearby mobile device has initiated an emergency communication to an emergency service system, the nearby mobile device within a communication range of the mobile device, and the emergency communication identifiable via the network traffic; determining a location where an emergency situation exists based on location information corresponding to the emergency communication; determining whether a user of the mobile device has a registered attribute corresponding to an emergency type identified from keywords or metadata of the emergency communication; and in response to determining that the user has the registered attribute, generating an alert on the mobile device including the location and information related to the emergency situation.

In Example 32, the subject matter of Example 31 includes, wherein the location is based on a location of the nearby mobile device.

In Example 33, the subject matter of Examples 31-32 includes, wherein the registered attribute includes at least one of CPR knowledge, firefighting training, medical training, crowd control training, law enforcement training, or suicide counseling and wherein the emergency type includes an injury, a fire, a medical emergency, a crowd emergency, or a law enforcement emergency.

In Example 34, the subject matter of Examples 31-33 includes, wherein the one or more hardware processors are further configured to perform operations comprising automatically retrieving a tutorial or video relevant to the registered attribute.

In Example 35, the subject matter of Examples 31-34 includes, wherein the one or more hardware processors are further configured to perform operations comprising notifying a set of other mobile devices at the location that the emergency situation exists.

In Example 36, the subject matter of Example 35 includes, wherein notifying the set of other mobile devices includes setting a beacon indicating the emergency situation exists at the location.

In Example 37, the subject matter of Examples 31-36 includes, wherein the one or more hardware processors are further configured to perform operations comprising determining the location based on signal strength information between the nearby mobile device and each of a group of notified mobile devices.

In Example 38, the subject matter of Examples 31-37 includes, wherein identifying that the nearby mobile device has initiated the emergency communication includes detecting a beacon activated by the nearby mobile device.

Example 39 is an apparatus for providing an emergency service, the apparatus comprising: means for identifying from network traffic based on wireless signals received by the mobile device, at a processor of the mobile device, that a nearby mobile device has initiated an emergency communication to an emergency service system, the nearby mobile device within a communication range of the mobile device, and the emergency communication identifiable via the network traffic; means for determining a location where an emergency situation exists based on location information corresponding to the emergency communication; means for determining whether a user of the mobile device has a registered attribute corresponding to an emergency type identified from keywords or metadata of the emergency communication; and in response to determining that the user has the registered attribute, means for generating an alert on the mobile device including the location and information related to the emergency situation.

In Example 40, the subject matter of Example 39 includes, wherein the location is based on a location of the nearby mobile device.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-40.

Example 43 is a system to implement of any of Examples 1-40.

Example 44 is a method to implement of any of Examples 1-40.

1. A method performed by an emergency service system comprising:
receiving, at a processor of the emergency service system, a plurality of emergency communications from a corresponding plurality of user devices;
determining an emergency location based on locations of the plurality of user devices based on the plurality of emergency communications;
determining whether the plurality of emergency communications at the emergency location exceed a threshold number of emergency communications; and
identifying proximate user devices within a predefined proximity of the emergency location based on collected location signals associated with the proximate user devices;
sending, in response to determining that the threshold number of emergency communications has been exceeded, an alert to at least one of the proximate user devices that did not provide one of the plurality of emergency communications.

2. The method of claim 1, further comprising determining a type of alert based on the plurality of emergency communications, the alert having the type.

3. The method of claim 1, wherein the plurality of emergency communications include at least one text message and at least one phone call.

4. The method of claim 1, wherein sending the alert includes sending the alert to at least one device not among the plurality of user devices based on a location of the at least one device corresponding to the emergency location.

5. The method of claim 1, further comprising refraining from sending the alert to at least one other user device of the plurality of user devices based on the at least one other user device not being in or near the emergency location.

6. The method of claim 1, wherein sending the alert includes sending the alert to all of the plurality of user devices.

7. The method of claim 1, wherein sending the alert includes sending the alert to all of the proximate user devices.

8. The method of claim 1, wherein the proximate user devices are identified directly from the proximate user devices themselves or through a server based on respective IP addresses of the proximate user devices.

9. A device for providing emergency service-related information, the device comprising:
one or more hardware processors;
a memory, storing instructions, which when executed, cause the one or more hardware processors to perform operations comprising:
receiving a plurality of emergency communications from a corresponding plurality of user devices;
determining an emergency location based on locations of the plurality of user devices based on the plurality of emergency communications;
determining whether the plurality of emergency communications at the emergency location exceed a threshold number of emergency communications; and
identifying proximate user devices within a predefined proximity of the emergency location based on collected location signals associated with the proximate user devices;
sending, in response to determining that the threshold number of emergency communications has been exceeded, an alert to at least one of the proximate user devices that did not provide one of the plurality of emergency communications.

10. The mobile device of claim 9, wherein the one or more hardware processors are further configured to perform operations comprising determining a type of alert based on the plurality of emergency communications, the alert having the type.

11. The mobile device of claim 9, wherein the plurality of emergency communications include at least one text message and at least one phone call.

12. The mobile device of claim 9, wherein sending the alert includes sending the alert to at least one device not among the plurality of user devices based on a location of the at least one device corresponding to the emergency location.

13. The mobile device of claim 9, wherein the one or more hardware processors are further configured to perform operations comprising refraining from sending the alert to at least one other user device of the plurality of user devices based on the at least one other user device not being in or near the emergency location.

14. The mobile device of claim 9, wherein sending the alert includes sending the alert to all of the plurality of user devices.

15. The mobile device of claim 9, wherein sending the alert includes sending the alert to all of the proximate user devices.

16. The mobile device of claim 9, wherein the proximate user devices are identified directly from the proximate user devices themselves or through a server based on respective IP addresses of the proximate user devices.

17. An apparatus for providing emergency service-related information, the apparatus comprising:
means for receiving a plurality of emergency communications from a corresponding plurality of user devices;
means for determining an emergency location based on locations of the plurality of user devices based on the plurality of emergency communications;
means for determining whether the plurality of emergency communications at the emergency location exceed a threshold number of emergency communications; and
means for identifying proximate user devices within a predefined proximity of the emergency location based on collected location signals associated with the proximate user devices;
means for sending, in response to determining that the threshold number of emergency communications has been exceeded, an alert to at least one of the proximate user devices that did not provide one of the plurality of emergency communications.

18. The apparatus of claim 17, further comprising means for determining a type of alert based on the plurality of emergency communications, the alert having the type.

19. The apparatus of claim 17, wherein the plurality of emergency communications include at least one text message and at least one phone call.

20. The apparatus of claim 17, wherein the means for sending the alert include means for sending the alert to at least one device not among the plurality of user devices based on a location of the at least one device corresponding to the emergency location.
